(19) United States
(12) Patent Application Publication
(10) Pub. No.: US 2011/0153587 A1
(43) Pub. Date: Jun. 23, 2011

(54) INDEXING SYSTEM

(76) Inventor: Chandrasagaran Murugan, Morningside (ZA)

(21) Appl. No.: 13/060,036

(22) PCT Filed: Aug. 21, 2009
(86) PCT No.: PCT/IB2009/053690

§ 371 Date: Feb. 21, 2011

(30) Foreign Application Priority Data
Aug. 21, 2008 (ZA) 200807257

(51) Int. Cl. G06F 17/30

(52) U.S. Cl. 707/706; 707/769; 707/741; 707/E17.014; 707/E17.108; 707/E17.002

(57) ABSTRACT

This invention relates to an indexing system, and to a method of operating an indexing system, the method comprising receiving a request from a user by way of a receiver module, the request including at least a unique identifier; accessing a database, by way of an association module communicatively coupled to the database and the receiver module, to retrieve at least one Uniform Resource Locator (URL) associated with the unique identifier received from the user, the database storing a plurality of unique identifiers for goods or services and URLs associated with the goods, persons or services; and transmitting the at least one retrieved URL to the user by way of a transmission module communicatively coupled to the association module.

### BACKGROUND OF THE INVENTION

THIS invention relates to an indexing system and also to a method of operating the indexing system.

Due to the sheer volume of data on the Internet users often experience great difficulties in effectively searching for goods and/or services which they desire on the Internet. Internet search engines alleviate this problem to a certain degree but they are often unreliable in locating the exact goods and/or services which a user desires.

It follows that it is an object of the present invention to address the problem above and to provide a more effective way to facilitate searching for goods and/or services on the Internet.

### SUMMARY OF THE INVENTION

According to a first aspect of the invention, there is provided a method of operating an indexing system, the method comprising:
receiving a request from a user by way of a receiver module, the request including at least a unique identifier;
accessing a database, by way of an association module communicatively coupled to the database and the receiver module, to retrieve at least one Uniform Resource Locator (URL) associated with the unique identifier received from the user, the database storing a plurality of unique identifiers for goods or services and URLs associated with the goods, persons or services; and
transmitting the at least one retrieved URL to the user by way of a transmission module communicatively coupled to the association module.

The method may further comprise:
generating or receiving unique identifiers for the goods, persons, or services; and
storing the unique identifiers in the database.

It will be appreciated that “persons” may be understood to include natural and legal persons such as companies, associations, or the like.

The method may comprise storing URLs associated with the goods, persons, or services in the database.

The method may comprise associating URLs with respective unique identifiers.

The unique identifiers may comprise alphanumeric characters and/or strings.

The alphanumeric strings may be extensible alphanumeric strings which may comprise information indicative of goods, persons, or services which the respective URLs are associated with.

The method may comprise receiving the request from the user via a search engine accessed by a user.

The method may comprise:
receiving a unique identifier from a user associated with a particular URL; and
connecting the user or computing device associated with the user to the particular URL.

According to a second aspect of the invention, there is provided an indexing system which includes:
a database storing a plurality of unique identifiers for goods or services and Uniform Resource Locators (URLs) associated with the goods or services;
a receiver module arranged to receive a request from a user, the request including at least a unique identifier;
an association module communicatively coupled to the database and the receiver module, the association module being arranged to access the database to retrieve at least one URL associated with the unique identifier received from the user; and
a transmission module communicatively coupled to the association module, the transmission module being arranged to transmit the at least one retrieved URL to the user.

The unique identifiers may be alphanumeric strings assigned to respective goods or services.

The unique identifiers may comprise characters and/or strings to identify the respective goods or services.

The receiver module may be arranged to receive the unique identifier via a communications network.

The receiver module may be arranged to receive the unique identifier from a search engine accessed by a user.

The system may comprise a unique identifier generating module arranged to generate a unique identifier for each good or service having an associated URL stored in the database.

The association module may be arranged to access the database to retrieve a list of URLs associated with the unique identifier received from the user.

### BRIEF DESCRIPTION OF THE DRAWINGS

FIG. 1 shows a schematic network diagram which includes the indexing system in accordance with an example embodiment;

FIG. 2 shows a flow diagram of a method of operating the indexing system of FIG. 1 in accordance with an example embodiment; and

FIG. 3 shows a schematic network diagram which includes the indexing system in accordance with an example embodiment.

### DESCRIPTION OF PREFERRED EMBODIMENTS

In the following description, for purposes of explanation, numerous specific details are set forth in order to provide a thorough understanding of an embodiment of the present disclosure. It will be evident, however, to one skilled in the art that the present disclosure may be practiced without these specific details.

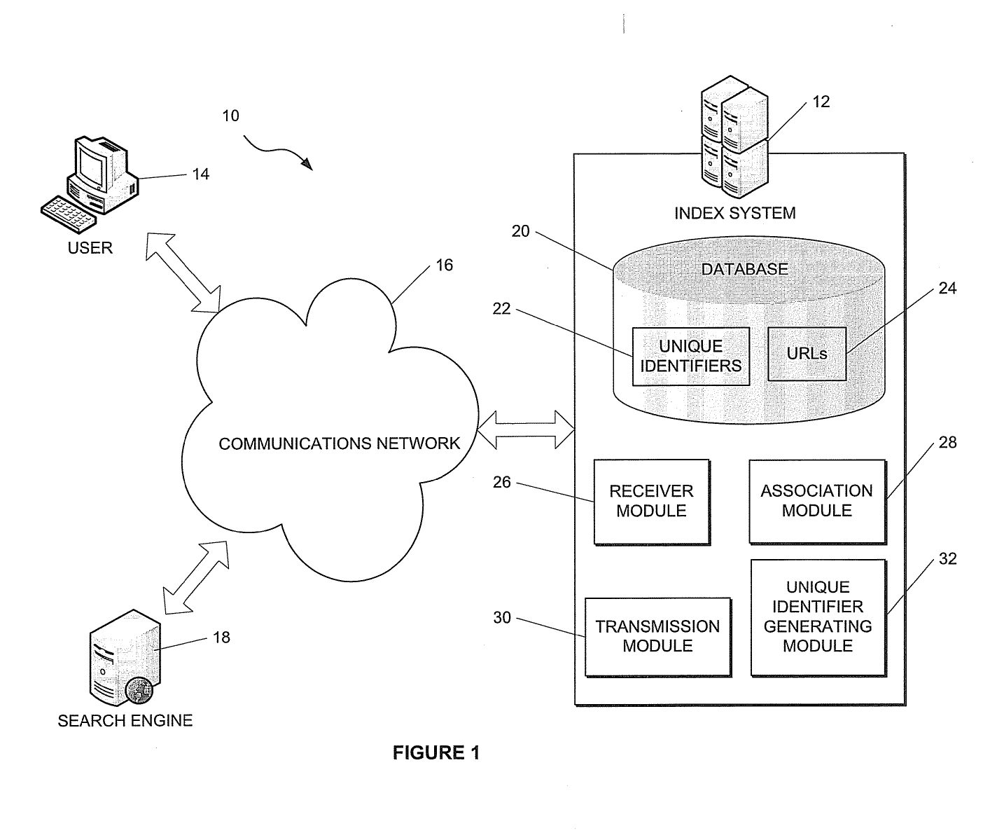

Referring to FIG. 1 of the drawings a network in accordance with an example embodiment is generally indicated by reference numeral 10. The network 10 includes an indexing system 12, in accordance with an example embodiment. The indexing system 12 comprises a plurality of components or modules which correspond to the functional tasks to be performed by the indexing system 12. In this regard, “module” in the context of the specification will be understood to include an identifiable portion of code, computational or executable instructions, data, or computational object to achieve a particular function, operation, processing, or procedure. It follows that a module need not be implemented in software, a module may be implemented in software, hardware, or a combination of software and hardware. Further, the modules need not necessarily be consolidated into one device but may be spread across a plurality of devices for example a plurality of devices across the network 10 such that the indexing system 12 can use the functionality provided by the modules from within the network 10.

Looking at FIG. 1 in more detail, the indexing system 12 is in communication with a plurality of users 14 thereof over a communications network 16. The communications network 16 may be a packet-switched network and may form part of the Internet. Instead, the communications network 16 may be a circuit switched network, public switched data network, or the like. For ease of illustration only one user 14 is shown, however, the network 10 typically comprises a plurality of users. It will be appreciated that the user 14 accesses the indexing system 12 via the communications network 16 by way of a computing device such as a personal computer, laptop, mobile communication device, or the like configured to communicate over the communications network 16.

In the illustrated embodiment, the network is the Internet and the indexing system 12 includes a webpage accessible by users via the Internet as will be discussed below. Instead, or in addition, the user 14 can optionally access the indexing system 12 by way of an Internet search engine 18 as will also be discussed below. It will be noted that in the latter example embodiment the search engine 18 is conveniently arranged to access the indexing system 12 via the communications network 16.

In summary, the indexing system 12 may be accessed in the following ways:

1. A website associated with the system 12

2. A toolbar that can be added to any web browser

3. A system widget on websites of companies.

4. Search engines will be granted access to the index created. The system 12 intends to serve as a utility to search engines

5. Search code browser adapted for mobile phones. On a mobile phone due to the lack of space for browsing, answers and not millions of links are more suited. The search browser for mobile phones only delivers the links indexed.

As mentioned above, the indexing system 12 comprises a plurality of components or modules, in particular the indexing system 12 includes a database 20 storing a plurality of unique identifiers 22 for goods or services and Uniform Resource Locators (URLs) 24 associated with the goods or services. The unique identifiers are conveniently alphanumeric strings assigned to respective goods or services. The unique identifiers are conveniently Globally Unique Extensible Internet Information Retrieval Strings or in other words search codes or Extensible Resource locators (ERLs). Typically, the unique identifiers are alphanumeric strings to at least identify the respective goods or services for example, for a product A from a manufacturer B the unique identifier may be manufacturerB—productA. In this way the unique identifier includes identifying information in the form of a suffix or prefix. The identifying information may also include a trademark associated with, for example, a company vending goods or services. In other example embodiments the unique identifier comprises information indicative of the country in which the user 14 is located. It follows that the URLs associated with the good or services are URLs to direct the user 14 to the website(s) of the manufacturers, vendors, or providers of the goods or services.

In one example embodiment, special characters are defined to add structure and extensibility to the unique identifiers. Examples of the special characters may be #, *, -, or the like. It will be understood that more special characters can be defined. Five types of unique identifiers may be provided in accordance with an example embodiment:

Type 1: General

Random alphanumeric string. Common Names also included. Maximum length of Type 1 a unique identifier is 10 characters. Type 1 unique identifiers can include extra characters for common names.

Format: xxxxxxxxxx

Examples: a, ph, xy23, car25,

Common Name Examples: car, orange, Guatemala

Type 2: Prefixed/Extensible

A company prefix combined with a separator and variable segment. Company Prefix guidelines

a. Full Company Name as prefix

b. Abbreviated company name as prefix

c. Keyword as company prefix

d. Random ASCI characters

Variable Segment are ASCII characters

A “-” is defined as the separator character

Format: company prefix-xxxxx

Example: sam-12, CAR-3, N-E70

Type 2 also allows for extensibility. SAM-12M can be allocated to the manual of SAM-12. SAM-12MV or SAM-12-MV can be the video manual of SAM-12

Type 3—Country specific

Any unique identifier followed by “country code” for country specific relevance

Format GUISS.country code

Example: a.br, car3.br

Type 4: Archived

A unique identifier with an archive suffix to enable reuse of a unique identifier. In other words, Type1 or Type2 or Type3 with archive suffix

Format: unique identifier#[number]

Example: ph#1, ph#2

Type 5: People

Name or Name prefix with a defined separator and variable segment.

Format: [Name, Name Prefix]*xxxx

Example: John*20, Sam*t, kj*jk

It will be noted that unique identifiers preferably have with few characters for consumers to easily remember and form associations. Trademark and Copyright identifiers as search codes as previously mentioned may be used. Company Prefix+ASCI characters as search code may be used. Full Company Name as prefix may be used. Abbreviated company name as prefix may be used. Keyword as company prefix may be used. Random ASCI characters may be used. Product Model Names—E70 for a brand of cellular telephone range model E70 may be used. Easily remembered character strings—SS5000 may be used. Random character string—SDFTXY may be used. Strings with a defined separator e.g. ab*dc may be used. An enabling separator may be re-used with an incrementing integer, e.g. ph,ph#1,ph#2. Country codes may be appended to the unique identifier for country relevance as hereinbefore described.

In addition, considering that a company name and product name together is more often than none unique, access to the URL links can be obtained by submitting the company name and product model. In the rare case of multiple companies sharing company names and product names a list will be delivered.

Example, for Camera Company A (CCA), and Cameral which Camera Company A manufactures, if the search code is CCA-C1, submitting CCA Camera 1 will also deliver the definitive URL links indexed for the search code.

As per the search code specification type 2 search codes are extensible. The “-” is the character reserved for enabling search codes to be extensible.

### Example 1

### Product

For a Camera 1 manufactured by Camera Company A (CCA) with search code CCA-C1, CCA-C1M or CCA-C1-M can be allocated for the camera manual. CCA-C1 FAQ or CCA-C1-FAQ can be allocated to the frequently asked questions for the camera

### Example 2

### Service

Law Practice, Law Firm 1—Search Code LF-

LF-P would be the search code for patent services offered by Law Firm 1. Further to this, LF-PC would be the search code for the Chemistry and Chemical engineering patent services offered by Law Firm 1.

In this way particular web-pages of a desired site may be indexed in accordance with an example embodiment. In other words, this allows the user to be directed to a specific page in a website.

The indexing system 12 also includes a receiver module 26 arranged to receive a request from a user 14, the request including at least a unique identifier.

An association module 28 is communicatively coupled to the database 20 and the receiver module 26. The association module 28 is arranged to access the database 20 to retrieve at least one URL associated with the unique identifier received from the user 14.

The indexing system 12 further includes a transmission module 30 communicatively coupled to the association module 28. The transmission module 30 is arranged to transmit the at least one retrieved URL to the user 14. The transmission module 30 is arranged to transmit or forward the retrieved URL to a web browser of the user 14 such that a webpage associated with the retrieved URL is automatically loaded to the user's 14 computing device. If the user 14 makes use of a search engine 18, then the transmission module 30 transmits the retrieved URL to the search engine 18 for presentation to the user 14. If the URL is presented to the user 14 in this fashion, the URL will typically be in the form of a link to the associated webpage. It will be noted that if multiple URLs are retrieved by the association module 28, the transmission module 30 will transmit a list of retrieved URLs to the user 14.

In an example embodiment the indexing system 12 further includes a unique identifier generating module 32 arranged to generate a unique identifier for each good or service having an associated URL stored in the database 20. It follows that manufacturers, providers or vendors of goods or services will provide a catalogue of goods and services and associated URLs to the system 12. In an example embodiment, the system 12 transmits a schedule of generated unique identifiers to the manufacturers for distribution to the public.

It will be appreciated that instead, or in addition, the manufacturers, providers or vendors of goods or services may optionally generate the unique identifiers associated with their respective goods or services. In this particular example embodiment, the generated unique identifiers, along with the associated URLs can be transmitted to the system 12 for storing in the database 20.

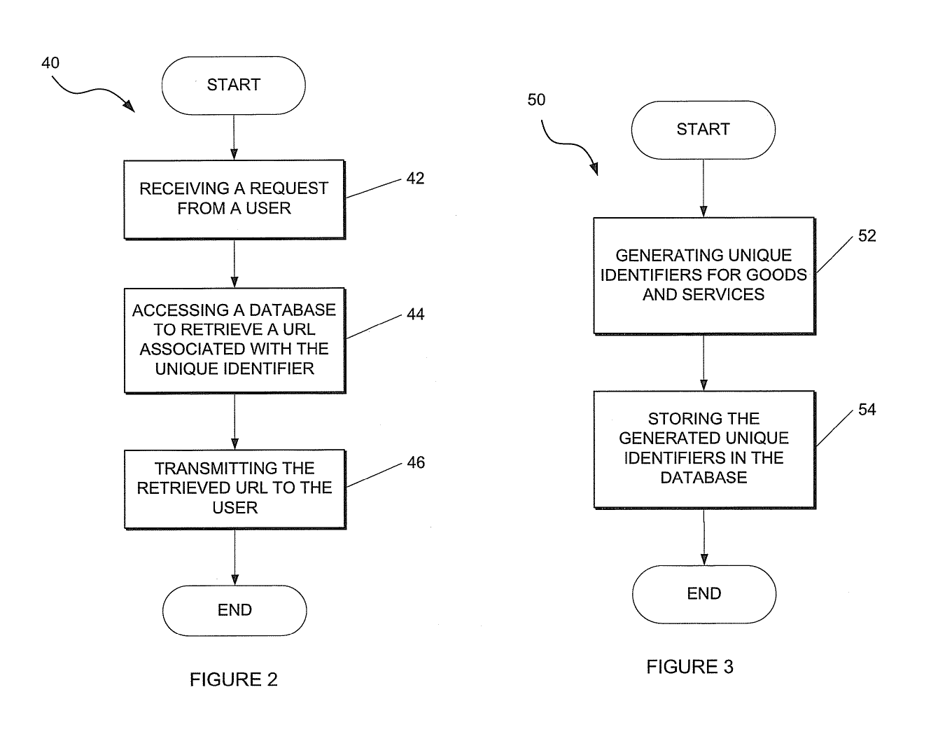

Example embodiments will now be further described in use with reference to FIGS. 2 and 3. The example methods shown in FIGS. 2 and 3 are described with reference to the system illustrated in FIG. 1, although it is to be appreciated that the example methods may be applicable to other systems (not illustrated) as well.

Referring to FIG. 2, a flow diagram of a method in accordance with an example embodiment is generally indicated by reference numeral 40. It will be borne in mind that the user 14 may conveniently have a list or catalogue of goods and services and their respective unique identifiers. This list may be obtained from, for example, the manufacturers, vendors or providers of the goods or services or from an advertisement for the goods or services.

When the user 14 wants to locate or find information on goods or services they will typically access the webpage of the system 12 and enter the unique identifier in a field provided therefor. Instead, or in addition, the user 14 submits the unique identifier for the goods or services they are interested in to the search engine 18. The search engine 18 then submits the unique identifier to receiver module 26.

In any event the method 40 includes receiving (block 42) a request from the user 14, for example by way of the receiver module 26. The request includes at least the unique identifier corresponding to the goods or services the user 14 desires.

The method 40 further includes accessing, at block 44, the database 20, for example by way of the association module 28 to retrieve at least one URL associated with the unique identifier received from the user 14.

Once the at least one URL is retrieved, the method 40 includes transmitting, at block 46, the at least one retrieved URL to the user 14 by way of the transmission module 30. As hereinbefore mentioned, the webpage associated with the retrieved URL can be automatically loaded to the user's 14 computing device.

Turning now to FIG. 3 of the drawings where a flow diagram of another method in accordance with an example embodiment is generally indicated by reference number 50.

The method 50 includes generating, at block 52, unique identifiers for goods or services whose associated URLs are to be stored in the database 20. It follows that unique identifiers are typically generated by the unique identifier generating module 32. As hereinbefore mentioned, the manufacturers, vendors or providers of the goods or services can optionally generate the unique identifiers.

It follows that the method 50 includes storing, at block 54, the unique identifiers in the database 20. In addition to the unique identifiers, the URLs associated with the identifiers are also stored in the database 20. These URLs are conveniently obtained from the manufacturers, vendors or providers of the goods or services.

In other example embodiments, the invention as hereinbefore described may conveniently be used to find URLs associated with people, companies etc. In these particular example embodiments, the people or companies have unique identifiers associated therewith and URLs to webpages associate therewith. These URLs can therefore be retrieved in a similar fashion to retrieval of the URLs for goods or services as described above.

The applicability of the search code system and methodology as hereinbefore described are primarily in the pre-purchase and post-purchase context.

In the pre-purchase context, adverts on traditional media platforms such as radio, television, and print inform the public of search codes for products. Further information prior to purchase is obtained with search code via one of the access methods mentioned above. The system 12 facilitates access to definitive product information directly. A link is provided between old media and new media services.

In the post purchase context, search codes will be found on products. If the manual or other relevant information for a purchases good, item, or service is sought, it is easily recovered with search codes.

The system as hereinbefore described with search codes delivers efficiency by providing more context and express links to information. The extensibility of search codes gives the search consumer more control of search. Companies can improve accessibility to information with search codes. Put another way, the online information coordinates of a product can be increased with search codes and a direct link is provided from the real world to the online world.

For search engines, the system 12 intends to serve as a utility. The system 12 will be made available to all search engines. Search engines primary revenue stream are derived from adverts tied to keywords. Keyword inventory is an important element to search engines. The system 12 with search codes is able to increase the keyword inventory of search engines as adverts can be tied to search codes also. It follows that the system aims to be profitable by increasing search engine revenue and charging and annual subscription fee for search codes.

It will be appreciated that, for conventional systems, if you enter “black pen” on a search engine that is crawler-page rank, or popularity score based, all the occurrences of those terms on the pages on the Internet indexed by the search engine is displayed. A filter which is popularity based is typically used to rank the results. So “black pen”, and all the anchors to “black”, and “pen” will be processed and delivered to the user.

In contrast, if “black pen” manufactured by company A is search coded in accordance with an example embodiment, (e.g. bp, or Company A-pb) then only one set of links will be displayed if a search code exists then the search coded links will be displayed as a priority. If however a search code does not exists then the fallback will be to search the details around the search code, such as the company name field and model name. In the event of two or more companies existing with the same names and product names then a list of links are delivered. If just a single term is entered that is not search coded then results from a conventional search engine will be delivered. It follows that results derived from a aggregate of a few search engines may be delivered to the user in accordance with an example embodiment.

The invention as hereinbefore described provides a more convenient and more accurate way to find information pertaining, in particular, to goods or services. By allowing the manufacturer, vendor, or provider of the goods to submit URLs to respective goods or services, a user of the indexing system can find more accurate information on the goods or services which he/she is interested in. Since the unique identifiers uniquely generated, should the user use an Internet search engine to search for goods or services, the user is not provided with as much search results which often include a lot of irrelevant information.

1. A method of operating an indexing system, the method comprising:
receiving a request from a user by way of a receiver module, the request including at least a unique identifier;
accessing a database, by way of an association module communicatively coupled to the database and the receiver module, to retrieve at least one Uniform Resource Locator (URL) associated with the unique identifier received from the user, the database storing a plurality of unique identifiers for goods or services and URLs associated with the goods, persons or services; and
transmitting the at least one retrieved URL to the user by way of a transmission module communicatively coupled to the association module.

2. A method as claimed in claim 1, the method comprising:
generating or receiving unique identifiers for the goods, persons, or services; and
storing the unique identifiers in the database.

3. A method as claimed in claim 1, the method comprising storing URLs associated with the goods, persons, or services in the database.

4. A method as claimed in claim 1, the method comprising associating URLs with respective unique identifiers.

5. A method as claimed in claim 1, wherein the unique identifiers comprise alphanumeric characters and/or strings.

6. A method as claimed in claim 5 wherein the alphanumeric strings are extensible alphanumeric strings which comprise information indicative of goods, persons, or services which the respective URLs are associated with.

7. A method as claimed in claim 1, the method comprising receiving the request from the user via a search engine accessed by a user.

8. A method as claimed in claim 1, the method comprising:
receiving a unique identifier from a user associated with a particular URL; and
connecting the user or computing device associated with the user to the particular URL.

9. An indexing system which includes:
a database storing a plurality of unique identifiers for goods or services and Uniform Resource Locators (URLs) associated with the goods or services;
a receiver module arranged to receive a request from a user, the request including at least a unique identifier;
an association module communicatively coupled to the database and the receiver module, the association module being arranged to access the database to retrieve at least one URL associated with the unique identifier received from the user; and
a transmission module communicatively coupled to the association module, the transmission module being arranged to transmit the at least one retrieved URL to the user.

10. An indexing system as claimed in claim 9 wherein the unique identifiers are alphanumeric strings assigned to respective goods or services.

11. An indexing system as claimed in claim 9, wherein the unique identifiers comprise characters and/or strings to identify the respective goods or services.

12. An indexing system as claimed in in claim 9, wherein the receiver module is arranged to receive the unique identifier via a communications network.

13. An indexing system as claimed in claim 9, wherein the receiver module is arranged to receive the unique identifier from a search engine accessed by a user.

14. An indexing system as claimed in claim 9, the system comprising a unique identifier generating module arranged to generate a unique identifier for each good or service having an associated URL stored in the database.

15. An indexing system as claimed in claim 9, wherein the association module is arranged to access the database to retrieve a list of URLs associated with the unique identifier received from the user.

16. (canceled)

17. (canceled)
